(19) United States
(12) Patent Application Publication
(10) Pub. No.: US 2020/0236241 A1
(43) Pub. Date: Jul. 23, 2020

(54) IMAGE FORMING APPARATUS AND POWER CONTROL DEVICE

(71) Applicant: CANON KABUSHIKI KAISHA, Tokyo (JP)

(72) Inventor: Takeshi Honda, Kashiwa-shi (JP)

(21) Appl. No.: 16/744,524

(22) Filed: Jan. 16, 2020

(30) Foreign Application Priority Data
Jan. 17, 2019 (JP) 2019-005750

(51) Int. Cl. H04N 1/00

(52) U.S. Cl. CPC H04N 1/00891; H04N 1/00007

(57) ABSTRACT

A power control device and an image forming apparatus capable of reducing a current at the time of power shutdown in an apparatus such as the image forming apparatus are provided. The image forming apparatus comprises a power source, an electrical driving load which is driven by the power source, a shutdown circuit for shutting down the power source from the electrical driving load, and a power shutdown circuit for controlling drive and stop operations of the electrical driving load and shutdown operation by the shutdown circuit. In a case where a signal giving an instruction to shut down the electrical driving load from the power source is input, the control circuit outputs a signal for stopping the electrical driving load and outputs a signal giving an instruction to shut down the electrical driving load from the power source to the shutdown circuit by delaying the signal.

### BACKGROUND OF THE INVENTION

### Field of the Invention

The present disclosure relates to an image forming apparatus and a power control device.

### Description of the Related Art

Conventionally, an image forming apparatus includes a printer, a copying machine or the like which prints an image by using an electrophotographic system. In such an apparatus, a door is provided to access inside the apparatus. A power control device with an interlock function is provided in the apparatus to prevent an electric shock or prevent a user from touching an electrical driving load which is driven by electricity in a case where the user opens the door and accesses inside the device. The interlock function turns on/off a power source of the electrical driving load in conjunction with opening and closing of the door.

For example, in an electrophotographic image forming apparatus, to form a toner image on a sheet on a basis of an image data on an image carrier such as a photosensitive drum and the like, an exposure process, a development process, and a transfer process are performed. Further, in the image forming apparatus, a fixing process for fixing the toner transferred onto the sheet by heat and pressure is also performed.

In such an image forming apparatus, a sheet is sometimes jammed within a conveying path inside the apparatus. In this case, a position where the sheet is jammed and a name of the door to be opened to remove the jammed sheet are displayed on a display part of the image forming apparatus. Further, in the image forming apparatus, to remove the jammed sheet, the user opens a door such as an exterior cover and puts his or her hand into the apparatus. Accordingly, a safety device is provided in the image forming apparatus. The safety device is to electrically shut down the electrical driving load in the image forming apparatus such as motors, a high voltage control circuit and the like to prevent the electrical shock to the user or prevent the user from being injured due to contact with the driving load in a case where the door is opened.

A power switch as an interlock is used as the safety device for shutting down the power source of an image forming unit. In a case where the power switch is used, a power shutdown circuit is provided so that a circuit is turned on or off in conjunction with the open/closed state of the door. By turning on or off the power source of the image forming unit in conjunction with the opening and closing of the door, a power source for opening the door by the user is shut down, which enables to easily remove the sheet jammed in the apparatus.

In the image forming apparatus, wiring between components may be long depending on an arrangement of the components. For example, in view of a configuration of the image forming apparatus, a door which is opened for removing the jammed sheet is often separated from a door which is opened for replacing a replacement component such as a toner bottle. In a device having a plurality of doors, it is necessary to arrange a plurality of power shutdown switches corresponding to each door. As a result, the wiring becomes long, and a voltage drop occurs due to wiring impedance, which may cause image degradation in the image forming apparatus.

Further, not only in the image forming apparatus but in an apparatus which is driven by power, in a case where a power line becomes long, the voltage drop due to the wiring impedance becomes a problem. In particular, in a device in which the power shutdown switches are arranged corresponding to a plurality of doors as in the image forming apparatus described above, the voltage drop due to the wiring impedance increases as the power line becomes long. To prevent such voltage drop, a method of controlling the power supply and shutdown by using a relay is proposed.

In Japanese Patent Application Laid-Open No. 2000-326589, a signal output from a sensor for detecting the opening and closing of the door is used as a control signal for conducting and shutting down the relay, thereby realizing the supply and shutdown of the power source in conjunction with the opening and closing of the door. In a case where the relay is used, the relay and the sensor for detecting the opening and closing of the door can be disposed at physically different positions, unlike the power shutdown switch described above. Accordingly, by disposing the relay near the power source of the image forming unit, the wiring can be made as short as possible.

However, in a case where the power source of the image forming apparatus is shut down by using the relay, it is necessary to use the relay having a breakdown voltage corresponding to inrush current flowing through the relay so that costs of the relay itself becomes expensive. Further, since, in the relay which uses a mechanical contact, a life of a mechanical contact portion tends to be short as the current flowing in a case where the relay is turned ON or OFF increases, a semiconductor switching element such as a field effect transistor (FET) is sometimes used instead of the mechanical contact point.

Since the semiconductor switching element has no mechanical contact, the life does not become extremely short in normal operation. However, in a case where the current is flowing through the semiconductor switching element at the time of shutdown, power is applied to the semiconductor switching element according to magnitude of the current. For example, in a case where a current of several amperes (A) flows, it sometimes exceeds a rated power of an element normally used in the image forming apparatus and the like. It is possible to use an element with large rated power though, in this case, the costs of using the element having the large rated power may be higher than the costs of using the relay. In addition, not only the semiconductor switching element but in the switching circuit, if the current flowing at the time of shutdown is large, the power applied at the time of shutdown is also large, which may cause damage to the switching circuit.

### SUMMARY OF THE INVENTION

An image forming apparatus according to the present disclosure includes: a power source; an electrical driving load which is driven by the power source; a power shutdown circuit configured to shut down power supply from the power source to the electrical driving load; and a control circuit configured to control a drive operation of the electrical driving load, a stop operation of the electrical driving load, and a power shutdown operation in the power shutdown circuit, wherein the control circuit is configured to: output, in a case where a state signal is input, a signal for stopping the electrical driving load; and output, to the power shutdown circuit, a signal for giving an instruction for shutting down power supply from the power source to the electrical driving load with a delay of a predetermined time or more from the output of the signal for stopping the electrical driving load, and wherein the state signal is a signal indicating a state of the image forming apparatus in which the stop operation of the electrical driving load and shutting down of power supply from the power source to the electrical driving load are required.

Further features of the present disclosure will become apparent from the following description of exemplary embodiments (with reference to the attached drawings).

### BRIEF DESCRIPTION OF THE DRAWINGS

FIG. 1 is an explanatory diagram of a configuration of an image forming apparatus.

FIG. 2 is an explanatory diagram of a device housing of the image forming apparatus.

FIG. 3 is a configuration diagram of a control circuit.

FIG. 4 is a timing chart of a control signal.

### DESCRIPTION OF THE EMBODIMENTS

In the following, preferred embodiments of the present disclosure will be described with reference to the drawings. It should be noted that the configuration and the circuit of the apparatus described in the present embodiment are only examples for explaining the present disclosure, and the present disclosure is not limited to the described embodiments.

### Outline of Image Forming Apparatus

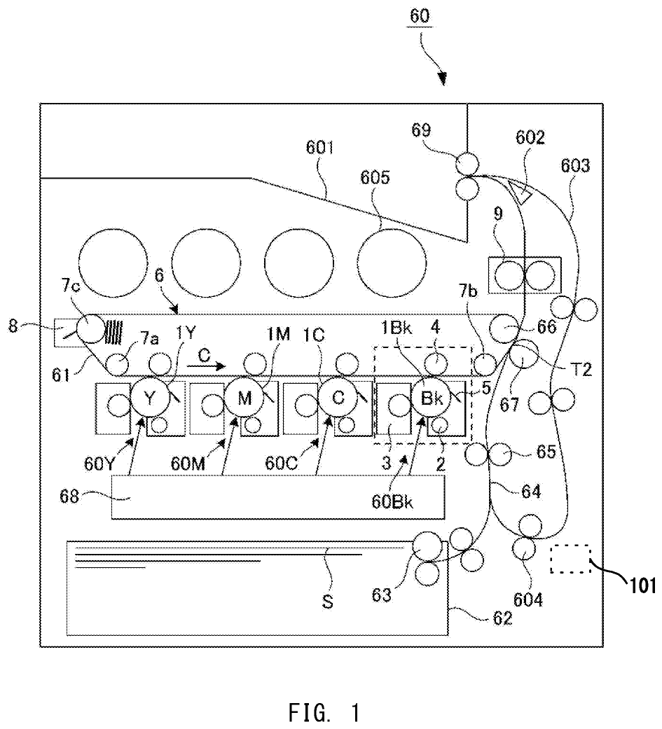

FIG. 1 is an explanatory diagram of a configuration of the image forming apparatus according to a first embodiment. As shown in the drawing, an image forming apparatus 60 is a full-color printer of a tandem type intermediate transfer system in which image forming apparatuses 60Y, 60M, 60C, and 60Bk are arranged along a downward surface of an intermediate transfer belt 61.

In the image forming apparatus 60Y, a yellow toner image is formed on a photosensitive drum 1Y and transferred to the intermediate transfer belt 61. In the image forming apparatus 60M, a magenta toner image is formed on a photosensitive drum 1M and transferred to the intermediate transfer belt 61. In the image forming apparatuses 60C and 60Bk, a cyan toner image and a black toner image are formed on photosensitive drums 1C and 1Bk respectively, and transferred to the intermediate transfer belt 61.

The toner images of the four colors transferred to the intermediate transfer belt 61 are conveyed to a second transfer unit T2 and transferred to a printing sheet S. A separation roller 63 separates the printing sheets S drawn out from a printing sheet cassette 62 one by one and sends the printing sheet S to a registration roller 65. The registration roller 65 sends the printing sheet S to the second transfer unit T2 by matching timing with the toner image of the intermediate transfer belt 61. The printing sheet S to which the toner images of the four colors are transferred is heated and pressurized by a fixing device 9, and the toner image is fixed on the surface of the printing sheet S.

The image forming apparatuses 60Y, 60M, 60C, and 60Bk are constituted almost identical to one another except that the colors of the toners used in the respective developing devices 3 are different from one another. Specifically, yellow toner is used in the developing device 3 of the image forming apparatus 60Y, magenta toner is used in the developing device 3 of the image forming apparatus 60M, cyan toner is used in the developing device 3 of the image forming apparatus 60C, and black toners is used in the developing device 3 of the image forming apparatus 60Bk. In the following, the image forming apparatus 60Bk will be described. With regard to the rest of the image forming apparatuses 60Y, 60M, and 60C, a description overlapping to the image forming apparatus 60Bk will be omitted.

In the image forming apparatus 60Bk, a charging device 2, an exposure device 68, the developing device 3, a transfer roller 4, and a drum cleaning device 5 are arranged surrounding the photosensitive drum 1Bk. The photosensitive drum 1Bk has a photosensitive layer formed on an outer peripheral surface of an aluminum cylinder and rotates at a predetermined process speed.

The charging device 2 applies a voltage obtained by superimposing an AC voltage on a negative DC voltage to a charging roller to charge the photosensitive drum 1Bk to a uniform negative potential. The exposure device 68 scans a laser beam obtained by ON-OFF modulating a scanning line image signal in which images of respective colors are developed with a rotation mirror, and writes an electrostatic image of the image on a surface of the photosensitive drum 1Bk. The developing device 3 transfers the toner to the photosensitive drum 1Bk to develop the electrostatic image into a toner image. A new amount of toner corresponding to the amount of toner consumed for image formation in the developing device 3 is supplied from a toner cartridge 605 to the developing device 3 via a toner conveying path (not shown).

In a case where a positive DC voltage is applied to the transfer roller 4 as a transfer unit, a negative toner image carried on the photosensitive drum 1Bk is transferred to the intermediate transfer belt 61. The drum cleaning device 5 rubs the photosensitive drum 1Bk with a cleaning blade to recover transfer residual toner remaining on the surface of the photosensitive drum 1Bk.

The intermediate transfer belt 61 is supported by a tension roller 7c, a drive roller 66 also serving as a second transfer counter roller, and tension rollers 7a and 7b, and is driven by the drive roller 66 to rotate in an arrow C direction. In a case where the positive DC voltage is applied to a second transfer roller 67 as the second transfer unit T2, the toner image on the intermediate transfer belt 61 is transferred to the printing sheet S. A belt cleaning device 8 causes the cleaning blade to rub against the intermediate transfer belt 61 to recover the toner remaining on the surface of the intermediate transfer belt 61.

The image forming apparatus 60 is provided with a power control device 101 having the interlock function for performing on/off operation of supplying power to an image forming load such as the motors, the high voltage control circuit and the like according to the open/closed state of the door of the image forming apparatus. The power control device 101 stops supplying power to the image forming load in a case where the user opens the door of the image forming apparatus due to the paper jam or the like and accesses inside the image forming apparatus. Due to this, the user can work safely.

### Apparatus Housing

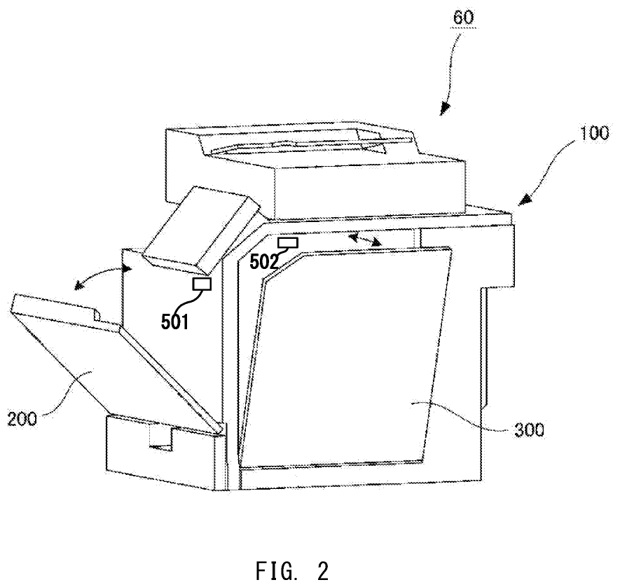

FIG. 2 is an explanatory diagram of an apparatus housing of the image forming apparatus. As shown in the drawing, in the image forming apparatus 60, doors are provided on a front surface and a side wall surface of the apparatus which are opened and closed for maintenance such as jam processing, replacement of consumables and the like. The doors are a front door 200 provided on the front surface of the image forming apparatus 60 and a right door 300 provided on a right side surface of the image forming apparatus. A front door sensor 501 is provided at a position facing the front door 200, and a right door sensor 502 is provided at a position facing the right door 300. The sensors detect the opening and closing of the door.

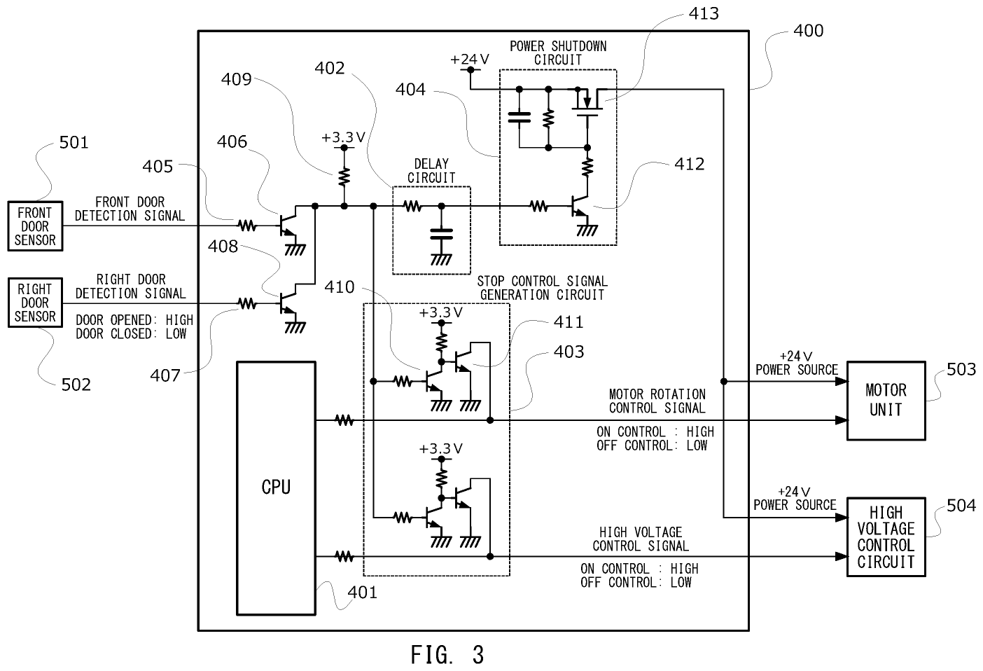

In a case where one of (or both of) the front door 200 and the right door 300 is in an opened state, the power control device 101 shuts down power from a power source which supplies power to the image forming load. A detailed configuration for performing the power shutdown will be described with reference to FIG. 3 which is described later.

Table 1 shows a power supply and shutdown state to the image forming unit in a case where each of the front door 200 and the right door 300 is in an opened state or in a closed state.

TABLE 1

| | | | POWER SOURCE |
|---|---|---|---|
| | FRONT DOOR | RIGHT DOOR | STATE |
| (a) | OPEN | OPEN | SHUTDOWN |
| (b) | OPEN | CLOSE | SHUTDOWN |
| (c) | CLOSE | OPEN | SHUTDOWN |
| (d) | CLOSE | CLOSE | SUPPLY |

As shown in (a), (b), and (c) in Table 1, in a case where at least one of the front door 200 and the right door 300 is opened, the power control device 101 shuts down the power from the power source to the image forming load. Thereby, a movable portion inside the image forming apparatus 60 is stopped, which secures safety of user's work for removing the jammed paper. As shown in (d) in Table 1, the power control device 101 supplies power source to the image forming unit to enable the image formation only in a case where both the front door 200 and the right door 300 are closed.

### Power Shutdown Circuit

FIG. 3 is an explanatory diagram of a control board 400 of the image forming apparatus 60. In the present embodiment, the power control device 101 comprises the control board 400. A power shutdown circuit 404 is mounted on the control board 400, and the control board 400 is provided on a rear surface of the image forming apparatus 60. A front door sensor 501, a right door sensor 502, a motor unit 503, and a high voltage control circuit 504 are connected to the control board 400. A CPU 401 as one of processors for controlling operation of the electrical driving load controls operation of the motor unit 503 and the high voltage control circuit 504. The power shutdown circuit 404 is a circuit for controlling conduction and shutdown of a 24V power source which is a power source of the motor unit 503 and the high voltage control circuit 504 according to a signal which is input from a delay circuit 402 which is a time constant circuit consisting of a resistor and a capacitor.

A front door detection signal output from the front door sensor 501 is input to the delay circuit 402 via a resistor 405 and a transistor 406. The front door detection signal is a signal which represents open/close of the front door 200. A right door detection signal output from the right door sensor 502 is also input to the delay circuit 402 via a resistor 407 and a transistor 408. The right door detection signal is a signal which represents open/close of right door 300. Collector terminals of the transistors 406 and 408 are wired OR connected. It should be noted that, as shown in the drawing, emitters of each of the transistors 406, 408, 410, 411, and 412 are grounded.

The front door sensor 501 and the right door sensor 502 are sensors for detecting opening and closing of the door. Each sensor outputs High voltage in a case where the door is in the opened state, and outputs Low voltage in a case where the door is in the closed state. In a case where at least one of the front door 200 and the right door 300 is in the opened state so that at least one of the front door sensor 501 and the right door sensor 502 outputs the High voltage, at least one of the transistors 406 and 408 is turned on.

Since the emitters of the transistors 406 and 408 are grounded, the collector terminal of the transistor which is turned to the on state is also grounded and outputs the Low voltage. Accordingly, in a case where at least one of the front door 200 and the right door 300 is in the opened state, the Low voltage is input to the delay circuit 402.

In a case where both the front door sensor 501 and the right door sensor 502 are in the closed state and both output the Low voltage, both the transistors 406 and 408 are turned off In this case, the collector terminals of the transistor 406 and the transistor 408 are turned to a high impedance state and switched to the High voltage by a resistor 409 which is connected to the 3.3V power source. Accordingly, in a case where both the front door 200 and the right door 300 are in the closed state, the High voltage is input to the delay circuit 402.

Next, a stop control signal generation circuit 403 will be described. The stop control signal generation circuit 403 and the power shutdown circuit 404 control the drive and stop operations and the shutdown operation of the motor unit 503 and the high voltage control circuit 504. Similar to the delay circuit 402, the stop control signal generation circuit 403 is connected to the collector terminals of the transistors 406 and 408. The stop control signal generation circuit 403 outputs a motor rotation control signal and a high voltage control signal.

The motor rotation control signal will be described. The collector terminals of the transistors 406 and 408 are connected to the base of the transistor 410, and the emitter thereof is grounded. The collector of the transistor 410 is connected to the base of the post-stage transistor 411 and is also connected to the 3.3V power source via the resistor. Further, the emitter of the transistor 411 is grounded and its collector is connected to the motor rotation control signal.

In this configuration, in a case where the High voltage is output from either the front door sensor 501 or the right door sensor 502 (door opened state), at least one collector terminal of the transistors 406 and 408 is switched to the Low voltage. Accordingly, an input voltage to the base of the transistor 410 is also switched to the Low voltage, and the transistor 410 is turned off. As a result, the transistor 411 is turned on, the motor rotation control signal is switched to the Low voltage, and the motor unit 503 is turned off. That is, the High voltage signal which is output from the front door sensor 501 and the right door sensor 502 becomes a signal indicating the state of the image forming apparatus (door opened) in which the operation to stop the motor unit 503 and the high voltage control circuit 504 is required. The High voltage signal which is output from the front door sensor 501 and the right door sensor 502 is also a signal indicating the state of the image forming apparatus (door opened) in which shutting down the power supply to the motor unit 503 and the high voltage control circuit 504 is required.

On the other hand, in a case where the Low voltage is output from both the front door sensor 501 and the right door sensor 502 (door closed state), the collector terminals of the transistors 406 and 408 are switched to the High voltage. Therefore, in a case where the transistor 410 is turned on and the transistor 411 is turned off, the motor rotation control signal is switched to the High voltage, and the motor unit 503 is turned on.

The high voltage control signal is provided with two transistors similar to the transistors 410 and 411 connected to a motor rotation control signal line. Accordingly, in a case where the High voltage is output from either the front door sensor 501 or the right door sensor 502 (door opened state), the high voltage control signal is switched to the Low voltage, and the high voltage control circuit 504 is turned off.

On the other hand, in a case where the Low voltage is output from both the front door sensor 501 and the right door sensor 502 (door closed state), the high voltage control signal is switched to the High voltage, and the high voltage control circuit 504 is turned on.

### Operation Sequence of Power Shutdown Circuit

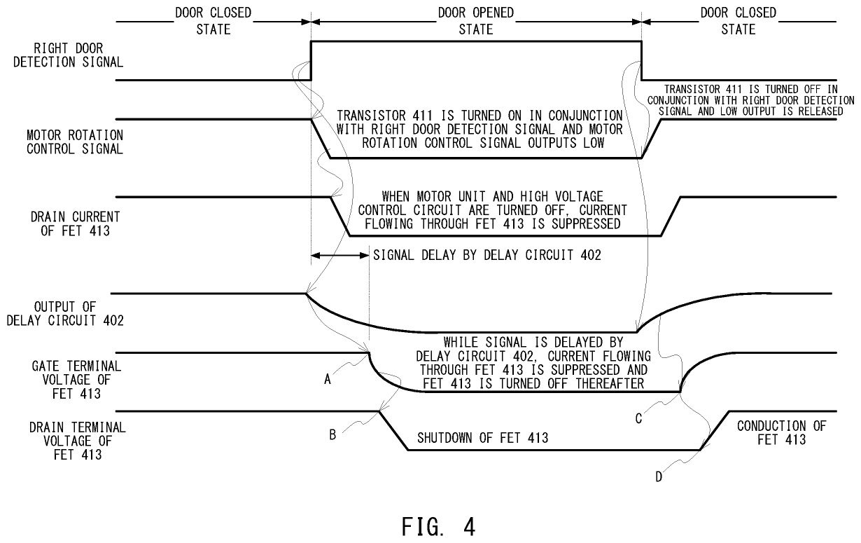

FIG. 4 shows a timing chart of a right door detection signal in a case where the right door 300 is opened and closed, the motor rotation control signal, a drain cunent of an FET 413, and an output of the delay circuit 402. The drain cunent is a cunent which flows through a drain terminal voltage of the FET 413. It should be noted that, in FIG. 4, a horizontal axis represents time, and a vertical axis represents voltage. The timing chart of FIG. 4 also shows a gate terminal voltage of the FET 413 and a drain terminal voltage of the FET 413. It should be noted that, in the following description, it is assumed that the front door 200 is always in the closed state, and the Low voltage indicating that the door is closed is always output from the front door sensor 501.

The motor rotation control signal and the high voltage control signal will be described. As shown in the drawing, in a case where the right door 300 is shifted from the closed state to the opened state, the right door detection signal which is the output of the right door sensor 502 changes from the Low voltage to the High voltage. As a result, the transistor 408 is turned on and the transistor 410 is turned off as described above.

In a case where the transistor 410 is turned off, the transistor 411 is turned on as described above, and the motor rotation control signal is immediately turned off regardless of contents of the operation control of the CPU 401. That is, even if the CPU 401 outputs the motor rotation control signal of the High level, the motor rotation control signal is forcibly changed to the Low level by the transistor 411. Although only the motor rotation control signal is shown in FIG. 3, the same applies to the high voltage control signal. As a result, in response to the opening of the right door 300, the motor rotation control signal and the high voltage control signal are quickly voltage dropped, and both the motor unit 503 and the high voltage control circuit 504 as the electrical driving load are quickly stopped, and the current flowing through the 24V power source is suppressed.

Next, the power shutdown circuit 404 will be described. The delay circuit 402 is provided between the collector terminal of the transistor 408 and the power shutdown circuit 404. Accordingly, the signal from the collector of the transistor 408 is input to the delay circuit 402, and the output from the delay circuit 402 is input to the power shutdown circuit 404. The power shutdown circuit 404 has a transistor 412 and the FET 413 as a switching element, and the output of the delay circuit 402 is input to the base of the transistor 412. The emitter of the transistor 412 is grounded, and its collector is connected to the gate of the FET 413 via the resistor.

With such a configuration, in a case where the right door 300 is shifted from the closed state to the opened state, the signal from the collector of the transistor 408 is delayed by a predetermined time by a CR time constant of the delay circuit 402, and the output voltage of the delay circuit 402 is gradually changed from the High voltage to the Low voltage. In a case where the output voltage from the delay circuit 402 becomes lower than a predetermined value, the base voltage of the transistor 412 is also lowered, and the transistor 412 is turned off. Here, the collector of the transistor 412 is connected to the gate of the FET 413 via the resistor.

Therefore, in a case where the output voltage from the delay circuit 402 becomes lower than a predetermined value, the transistor 412 is shifted from on to off, and the gate terminal voltage of the FET 413 starts to decrease. In FIG. 4, the gate terminal voltage of the FET 413 is shown to decrease at a time point A. That is, due to a signal delay effect of the delay circuit 402, the gate terminal voltage of the FET 413 starts to decrease at the time point A at which predetermined time or more is delayed after the door is opened. Thereafter, the gate voltage of the FET 413 decreases, and in FIG. 4, the FET 413 is turned off at a time point B which is after the time point A, and the drain terminal voltage of the FET 413 decreases. As shown, at the time points A and B, since both the motor unit 503 and the high voltage control circuit 504 are already off, the drain current becomes small (or zero (0)).

As described above, in the present embodiment, it becomes possible to shut down the motor unit 503 and the high voltage control circuit 504 from the 24V power source by turning off the FET 413 in a state where the drain current is small. In a case where the drain current is flowing in a case where the FET 413 is shut down, the drain voltage drops while the FET 413 is turned off. As a result, power proportional to the drain current is applied to the FET 413 at a timing in a case where drain-source voltage increases.

However, in the present embodiment, by using the delay circuit 402, the stop control signal generation circuit 403 stops the motor unit 503 and the high voltage control circuit 504 before the FET 413 is turned off. As a result, after the drain current is made small or zero (0), the motor unit 503 and the high voltage control circuit 504 are shut down from the 24V power source. Therefore, the power applied to the FET 413 at the time of shutting down the FET 413 can be suppressed.

Next, a state of the FET 413 in which both the front door 200 and the right door 300 are brought into the closed state and the motor unit 503 and the high voltage control circuit 504 are connected to the 24V power source will be described.

In a case where the right door 300 is shifted from the opened state to the closed state, the signal which is output from the right door sensor 502 is changed from High to Low as shown in FIG. 4. This signal serves as a signal giving an instruction to shut down the motor unit 503 and the high voltage control circuit 504 from the 24V power source. In a case where the signal of the right door sensor 502 is switched to the Low voltage, the input voltage to the gate of the transistor 408 is also switched to the Low voltage. As a result, the transistor 408 is turned off and its collector terminal is turned to a high impedance state. As the collector of transistor 408 is connected to the 3.3V power source through the resistor 409, the voltage is shifted from the Low voltage to the High voltage.

First, the motor rotation control signal and the high voltage control signal will be described. In a case where the right door 300 is brought into the closed state and the voltage of the collector of the transistor 408 is shifted from the Low voltage to the High voltage, the transistor 410 is turned on, and the post-stage transistor 411 is turned off. In a case where the right door 300 is in the opened state, the motor rotation control signal is grounded through the transistor 411 as described above, but this ground state is released in a case where the transistor 411 is turned off. Accordingly, in a case where the right door 300 is shifted from the opened state to the closed state, the voltage value of the motor rotation control signal is controlled by the CPU 401. The same applies to the high voltage control signal. Accordingly, in a case where both the front door 200 and the right door 300 are brought into the closed state, the CPU 401 controls ON/OFF of the motor unit 503 and the high voltage control circuit 504.

Next, a power shutdown circuit will be described. In a case where the right door 300 is brought into the closed state and the voltage of the collector of the transistor 408 is shifted from the High voltage to the Low voltage, the output of the delay circuit 402 gradually rises from Low to High. In a case where the output of the delay circuit 402 reaches a predetermined value, the transistor 412 is turned on from off. As a result, the gate terminal voltage of the FET 413 rises from the Low voltage at a time point C shown in FIG. 4. That is, the gate terminal voltage of the FET 413 starts to rise at the time point C at which a predetermined time has elapsed after the door is closed due to the signal delay effect of the delay circuit 402. As a result, the drain voltage of the FET 413 starts to rise at a time point D after the time point C shown in FIG. 4, and the FET 413 becomes conductive. As a result, the motor unit 503 and the high voltage control circuit 504 are brought into conduction with the 24V power source, which enables to supply power.

As shown in FIG. 4, since the transistor 411 is turned off at a time point in a case where the right door 300 is brought into the closed state, the motor rotation control signal is released from the ground state, and a control signal corresponding to the operation control content is input to the motor unit 503 from the CPU 401. Accordingly, in a case where the FET 413 becomes conductive at the time point D, the operation including stop and drive of the motor unit 503 and the high voltage control circuit 504 is controlled by the control of the CPU 401.

As described above, in the present embodiment, the current at the time of shutting down the power from the power source of the image forming apparatus 60 by the front door 200 and the right door 300 is made small and the power applied at the time of shutting down is reduced. Accordingly, it is possible to use the power shutdown circuit having a lower rated power than a conventional circuit. In particular, in the present embodiment, in the power shutdown circuit, by using the semiconductor such as the inexpensive FET as the power shutdown unit instead of using the conventionally used power shutdown relay, it is possible to largely suppress costs. Further, a configuration for shutting down the power source of the image forming apparatus can be provided at low cost, and the life of the power shutdown/energization control can drastically be extended.

In the present embodiment, the image forming apparatus having the power control device is described, however, the power control device of the present embodiment can be adapted not only to the image forming apparatus but also to any apparatus using the power source. Further, in the present embodiment, the FET is used as the power shutdown circuit, however, in addition to the FET, other semiconductor switches can be used. In this case, since the power applied at the time of the power shutdown can be reduced, a power shutdown circuit having a small rated power and low cost can be used.

In the present embodiment, an example in which the power source is shut down by detecting the opening and closing of the two doors, namely, the front door 200 and the right door 300, is shown, but the number of doors is not limited to two. The number of doors may be one or may be three or more. In this case, in a case where at least one door is brought into the opened state, the motor unit 503 and the high voltage control circuit 504 are stopped to drive and the FET 413 is shut down, and in a case where all doors are brought into the closed state, the motor unit 503 and the high voltage control circuit 504 are driven and the FET 413 is conducted.

The power control device of the present embodiment can be applied to any device which shuts down the power source depending on whether or not it is necessary to shut down the power source, regardless of whether or not the device has the door. In this case, an arbitrary signal for requesting shutting down the power source is input to the power control device in place of the detection signal indicating that the door is open, and an arbitrary signal for requesting conduction of the power source is input in place of the detection signal indicating the door closing.

Further, according to the present disclosure, it is possible to provide the power control device and the image forming apparatus capable of reducing the current at the time of the power shutdown in the apparatus such as the image forming apparatus.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2019-005750, filed Jan. 17, 2019 which is hereby incorporated by reference herein in its entirety.

What is claimed is:

1. An image forming apparatus comprising:
a power source;
an electrical driving load which is driven by the power source;
a power shutdown circuit configured to shut down power supply from the power source to the electrical driving load; and
a control circuit configured to control a drive operation of the electrical driving load, a stop operation of the electrical driving load, and a power shutdown operation in the power shutdown circuit,
wherein the control circuit is configured to:
output, in a case where a state signal is input, a signal for stopping the electrical driving load; and
output, to the power shutdown circuit, a signal for giving an instruction for shutting down power supply from the power source to the electrical driving load with a delay of a predetermined time or more from the output of the signal for stopping the electrical driving load, and
wherein the state signal is a signal indicating a state of the image forming apparatus in which the stop operation of the electrical driving load and shutting down of power supply from the power source to the electrical driving load are required.

2. The image forming apparatus according to claim 1,
wherein the image forming apparatus comprises a door which is opened for a user to access inside the image forming apparatus, and
a signal indicating that the door is in an opened state is input to the control circuit as the state signal.

3. The image forming apparatus according to claim 2, further comprising
a door sensor for detecting opening and closing of the door, and
wherein the door sensor is configured to input a signal indicating that the door is in an opened state as the state signal to the control circuit in a case where the door sensor detects that the door is brought into an opened state.

4. The image forming apparatus according to claim 2,
wherein two or more doors are provided and a signal indicating that at least one of the doors is in an opened state is input to the control circuit as the state signal.

5. The image forming apparatus according to claim 1,
wherein the control circuit comprises a delay circuit configured to delay a signal, and
wherein the control circuit is further configured to input the signal for stopping the electrical driving load through the delay circuit to the power shutdown circuit.

6. The image forming apparatus according to claim 5,
wherein the power shutdown circuit is a switching element, and wherein the delay circuit is a time constant circuit consisting of a resistor and a capacitor.

7. The image forming apparatus according to claim 1,
wherein the image forming apparatus further comprises a load driving circuit for controlling the operation of the electrical driving load, and
wherein the control circuit is further configured to stop the operation of the electrical driving load regardless of a control state of the electrical driving load by the load driving circuit in a case where the state signal is input.

8. The image forming apparatus according to claim 7,
wherein the control circuit is further configured to change a level of a signal for operating the electrical driving load which is output from the load driving circuit to a level of a signal for stopping the electrical driving load in a case where a signal indicating the state is input.

9. A power control device which is used in an image forming apparatus comprising a power source and an electrical driving load which is driven by the power source,
wherein the power control device comprises a power shutdown circuit configured to shut down power supply from the power source to the electrical driving load, and a control circuit configured to control a drive operation of the electrical driving load, a stop operation of the electrical driving load, and a power shutdown operation in the power shutdown circuit, and
wherein the control circuit is configured to:
output, in a case where a state signal is input, a signal for stopping the electrical driving load, and
output, to the power shutdown circuit, a signal for giving an instruction for shutting down power supply from the power source to the electrical driving load with a delay of a predetermined time or more from the output of the signal for stopping the electrical driving load, and
wherein the state signal is a signal indicating a state of the image forming apparatus in which the stop operation of the electrical driving load and shutting down of power supply from the power source to the electrical driving load are required.
